(19) United States
(12) Patent Application Publication
(10) Pub. No.: US 2025/0178400 A1
(43) Pub. Date: Jun. 5, 2025

(54) ACTIVE HEAT SHARING BETWEEN CABIN AND HIGH VOLTAGE BATTERY

(71) Applicant: FORD GLOBAL TECHNOLOGIES, LLC, DEARBORN, MI (US)

(72) Inventors: Jordan Mazaira, Taylor, MI (US); Brett Allen Dunn, Plymouth, MI (US); Zachary March, Fort Collins, CO (US)

(21) Appl. No.: 18/400,616

(22) Filed: Dec. 29, 2023

Related U.S. Application Data
(60) Provisional application No. 63/606,421, filed on Dec. 5, 2023.

(51) Int. Cl. B60H 1/00; B60H 1/14; B60L 50/60; B60L 58/26; H01M 10/613; H01M 10/625; H01M 10/63; H01M 10/6568; H01M 10/66

(52) U.S. Cl. CPC B60H 1/00278; B60H 1/00828; B60H 1/00885; B60H 1/143; B60L 50/60; B60L 58/26; H01M 10/613; H01M 10/625; H01M 10/63; H01M 10/6568; H01M 10/66; B60H 2001/00307; H01M 2220/20

(57) ABSTRACT

A vehicle includes a traction battery and an electric machine powered by the traction battery and configured to power wheels of the vehicle. The vehicle further includes a thermal-management system having a battery loop configured to circulate coolant through the traction battery, a cabin heating loop configured to circulate coolant through a heater and a heater core, a blower configured to circulate air through the heater core to heat a passenger cabin of the vehicle, and a valve configured to fluidly connect the battery loop and the heating loop when the valve is in a first position and configured to fluidly isolate the battery loop from the heating loop when the valve is in a second position. A controller is programmed to, responsive to (i) the battery charging, (ii) a temperature of the battery being less than a first threshold, and (iii) a temperature of the heater core being greater than a second threshold, energize the heater and command the valve to toggle between the first and second positions in succession such that heat generated by the heater is circulated to the battery and the heater core.

### CROSS REFERENCE

This application claims the benefit of U.S. provisional application Ser. No. 63/606,421, filed Dec. 5, 2023, the disclosure of which is hereby incorporated in its entirety by reference herein.

### TECHNICAL FIELD

This disclosure relates to automotive climate systems.

### BACKGROUND

The high voltage battery in a hybrid vehicle or full electric vehicle may have a thermal range for operation. If the cells are colder than this range, the discharge power may be low. Cold batteries may also store less energy.

### BRIEF DESCRIPTION OF THE DRAWINGS

FIG. 1 is a schematic diagram of an example electric vehicle.

FIG. 2 is a schematic diagram of a thermal-management system of the vehicle.

FIGS. 3A-3B is a flow chart of an algorithm for operating the thermal-management system during charging of the battery.

FIGS. 4A-4C show a control diagram illustrating logic for switching between different modes of battery heating.

### SUMMARY

According to one embodiment, a vehicle includes a traction battery and an electric machine powered by the traction battery and configured to power wheels of the vehicle. The vehicle further includes a thermal-management system having a battery loop configured to circulate coolant through the traction battery, a cabin heating loop configured to circulate coolant through a heater and a heater core, a blower configured to circulate air through the heater core to heat a passenger cabin of the vehicle, and a valve configured to fluidly connect the battery loop and the heating loop when the valve is in a first position and configured to fluidly isolate the battery loop from the heating loop when the valve is in a second position. A controller is programmed to, responsive to (i) the battery charging, (ii) a temperature of the battery being less than a first threshold, and (iii) a temperature of the heater core being greater than a second threshold, energize the heater and command the valve to toggle between the first and second positions in succession such that heat generated by the heater is circulated to the battery and the heater core.

According to another embodiment, a vehicle includes an electric powertrain having a traction battery and an electric machine powered by the traction battery. A controller is programmed to, responsive to a temperature of the battery being less than a threshold temperature and an estimated distance to empty being greater than a threshold distance, command power to the electric machine according to an inefficient heat-generating mode that produces more heat from the battery and the electric machine than an efficient normal mode of operating the battery and the electric machine.

According to yet another embodiment, a method of heating a vehicle battery includes, responsive to a temperature of a battery being less than a threshold temperature and an estimated distance to empty being greater than a threshold distance, switching from an efficient normal operating mode to an inefficient heat-generating mode such that the battery, for a given power output, produces more heat compared to the normal operating mode.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Actively heating the battery can in some instances increase the available driving range. By heating the high-voltage battery, vehicle driving range may be extended and vehicle acceleration performance may be increased.

As will be described in more detail below, the vehicle's thermal system assesses the need for active battery thermal management based on the battery cell temperature and state of charge. If battery heating is desired, then cabin heating is checked. If cabin heating is OFF, battery heating is enabled. If cabin heating is ON but the vehicle has just started and the cabin is currently cold, some heat is delivered to the high-voltage battery for a short amount of time to warm the battery while slightly delaying cabin warm-up. If cabin heating is desired but the vehicle was not recently started, then plug state is checked. If the vehicle is DC charging, then only blower speed is checked for whether heating should be shared with the cabin or prioritized to the battery.

If the vehicle is not DC charging, further thresholds are checked to determine if there is excess heat capacity in the vehicle thermal system. These thresholds may include ambient temperature, climate defrost state, climate performance, and heater duty cycle. If there is excess heat capacity, then that heat is shared by both the cabin and the high voltage battery by moving a valve to distribute the warm coolant between the heater core and battery heat exchanger.

The valve is manipulated depending on the heater core temperature compared to a heater core temperature target. In some instances, the heater core temperature may be able to be maintained while still heating the high-voltage battery. In other instances, the valve will toggle between sharing heat with the high-voltage battery and dedicating heat to the heater core based on a calibrated timer table.

Heat sharing will continue until the high-voltage battery temperature target is reached or if excess heat is no longer available such as if a customer increases the cabin heating target or enables defrost mode.

The above may allow active heating of the battery while the vehicle is not charging and balancing the distribution of heat between the cabin and battery by moving a valve to maintain an acceptable cabin thermal performance while still providing some heat to the high voltage battery to enable warming. There are also expanded entry thresholds to determine excess heat capacity in the system.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

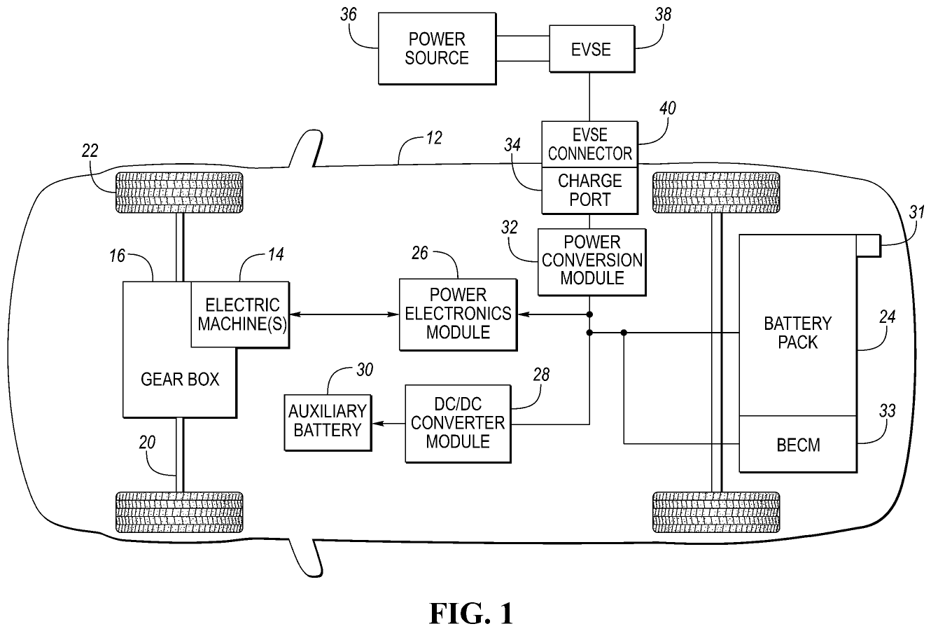

FIG. 1 depicts a schematic of an electric vehicle (BEV). Certain embodiments, however, may also be implemented within the context of plug-in hybrids. The vehicle 12 includes one or more electric machines (traction motors) 14 mechanically connected to a transmission or gearbox 16. The gearbox 16 may be a one-speed gearbox and may include a differential. The gearbox 16 is operably coupled to the driven wheels of the vehicle 22 by axle shafts 20.

A traction battery or battery pack 24 stores energy that can be used by the electric machines 14. The traction battery 24 typically provides a high-voltage direct current (DC) output from one or more battery cell arrays, sometimes referred to as battery cell stacks, within the traction battery 24. The battery cell arrays may include one or more battery cells.

The battery cells, such as a prismatic, pouch, cylindrical, or any other type of cell, convert stored chemical energy to electrical energy. The cells may include a housing, a positive electrode (cathode) and a negative electrode (anode). An electrolyte may allow ions to move between the anode and cathode during discharge, and then return during recharge. Terminals may allow current to flow out of the cell for use by the vehicle. Different battery pack configurations may be available to address individual vehicle variables including packaging constraints and power requirements. The battery cells may be thermally regulated with a thermal-management system. Examples of thermal-management systems include liquid cooling systems.

The traction battery 24 may be electrically connected to one or more power electronics modules 26 through one or more contactors (not shown). The one or more contactors isolate the traction battery 24 from other components when opened and connect the traction battery 24 to other components when closed. The power-electronics module 26 may be electrically connected to the electric machines 14 and may provide the ability to bi-directionally transfer electrical energy between the traction battery 24 and the electric machines 14. For example, a typical traction battery 24 may provide a DC voltage while the electric machines 14 may require a three-phase alternating current (AC) voltage to function. The power-electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle components. Other high-voltage loads, such as compressors, pumps, and electric heaters, may be connected directly to the high-voltage supply without the use of a DC/DC converter module 28. In a typical vehicle, the low-voltage systems are electrically connected to an auxiliary battery 30 (e.g., a 12-volt battery).

A battery energy control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature sensor. The temperature sensor 31 may be in communication with the BECM 33 to provide temperature data regarding the traction battery 24.

The vehicle 12 may be recharged by a charging station connected to an external power source 36. The external power source 36 may be electrically connected to electric vehicle supply equipment (EVSE) 38. The external power source 36 may provide DC and/or AC electrical power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to one or more chargers or on-board power conversion module 32. The charge port 34 may include a connector for AC charging and another connector for DC charging. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding pins of the charge port 34. The charge port 34 and the vehicle 12 may be configured to connect with a so-called “fast charge” charging station. During fast charge, the vehicle may receive a high-voltage DC current.

The various components discussed may have one or more controllers to control and monitor the operation of the components. The controllers may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, any reference to “a controller” refers to one or more controllers.

The traction battery 24 and other vehicle component are thermally regulated with one or more thermal-management systems. Example thermal-management systems are shown in the figures and described below.

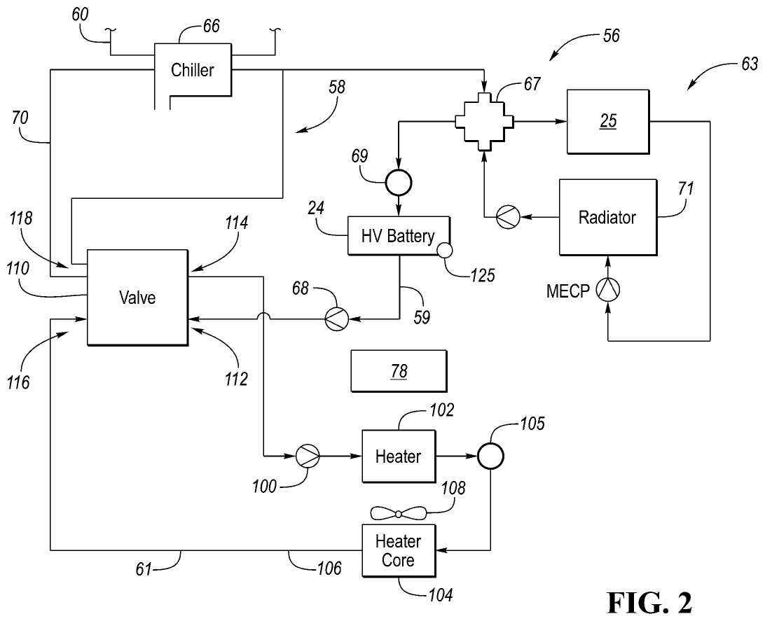

Referring to FIG. 2, a vehicle 12 includes a thermal-management system 56. The thermal-management system 56 manages thermal loads generated by various vehicle components, such as the battery assembly 24, powertrain components, power-electronic components 25, and the passenger cabin. For example, the thermal-management system 56 can selectively circulate coolant to the battery 24 to either cool or heat the battery depending on operating conditions.

The thermal-management system 56 may include one or more associated vehicle controllers 78. The controller 78 may be part of a larger control system and may be controlled by various other controllers throughout the vehicle, such as a vehicle-system controller (VSC) that includes a powertrain control unit, a transmission control unit, an engine control unit, a battery energy control module (BECM), a hybrid powertrain control model (HPCM), etc. It should be understood that the controller 78 and one or more other controllers can collectively be referred to as “a controller” that controls, such as through a plurality of integrated algorithms, various actuators in response to signals from various sensors to control functions associated with the vehicle, and in this case, with the thermal-management system 56. The various controllers that make up the VSC can communicate with one another using a common bus protocol (e.g., CAN).

In one embodiment, the thermal-management system 56 includes a coolant subsystem 58 and a refrigerant (heat pump) subsystem 60. These two loops may operate in tandem or independently of each other depending upon the battery cooling/heating requirements, the ambient-air temperature, the passenger cooling/heating requirements, and other factors. The refrigerant subsystem 60 may be a vapor-compression heat pump that circulates a refrigerant transferring thermal energy to various components of the thermal-management system. The refrigerant subsystem 60 may include the air-conditioning (AC) system for the cabin and the cooling system for the battery 24. Utilizing the cabin AC may be more cost effective than having a dedicated refrigerant system for the traction battery 24. The coolant subsystem 58 includes a battery loop 59 and a cabin heating loop 61. The battery loop 59 circulates coolant through the battery assembly 24. The battery loop 59 may be connected to a power-electronics loop 63 by a valve 67. The valve 67 includes a first position in which the battery loop 59 and the power-electronics loop 63 are isolated and a second position in which the battery loop 59 and the power-electronics loop are joined communication. In the illustrated embodiment, the radiator 71 is part of the loop 63, however, the radiator 71 may be part of the battery loop 59 in other embodiments, or alternatively, both loops may include their own radiator. The coolant may be a conventional coolant mixture, such as water mixed with ethylene glycol or other antifreeze. Other coolants could also be used by the coolant subsystem 58.

The battery loop 59 includes conduit, line, hosing, or tubing 70 that is configured to circulate the coolant through the battery 24 and a chiller 76. The coolant may be circulated by a pump 68. The battery loop 59 may also include temperature sensor 69 that is upstream of the battery 24 and configured to output data to the controller 78 indicative of a measured temperature of the coolant. A bypass valve 66 may be provided to bypass the chiller 76.

The chiller 76 exchanges heat with the refrigerant subsystem 60 to provide a chilled coolant during certain conditions. For example, when the battery temperature exceeds a predefined threshold and the cabin AC system 60 has capacity, the valve 66 may be actuated to circulate at least some coolant to the chiller 76. The warm coolant from the battery pack 24 may enter the chiller 76 and exchange heat with a refrigerant of the refrigerant subsystem 60 to dissipate heat. The battery chiller 76 may have any suitable configuration. For example, the chiller 76 may have a plate-fin, tube-fin, or tube-and-shell configuration that facilitates the transfer of thermal energy without mixing the heat-transfer fluids in the coolant subsystem 58 and the refrigerant subsystem 60.

The refrigerant subsystem 60, may include a compressor, a condenser, at least one cabin evaporator, the chiller, a first expansion device, a shutoff valve, a second expansion device, and a second shutoff valve. The compressor pressurizes and circulates the refrigerant through the refrigerant subsystem 60. The compressor may be powered by an electrical or non-electrical power source. A pressure sensor may monitor the pressure of the refrigerant exiting the compressor.

The refrigerant exiting the compressor may be circulated to the condenser by one or more conduits. The condenser transfers heat to the surrounding environment by condensing the refrigerant from a vapor to a liquid. A fan may be selectively actuated to circulate airflow across the condenser to further effectuate heat transfer between the refrigerant and the airflow.

At least a portion of the liquid refrigerant that exits the condenser may be circulated through the first expansion device (depending upon the position of valve) and then to the evaporator. The first expansion device is adapted to change the pressure of the refrigerant. In one embodiment, the first expansion device is an electronically controlled expansion valve (EXV). In another embodiment, the first expansion device is a thermal expansion valve (TXV) or a passive device. If the expansion device is an EXV, the shutoff valve can be omitted. The liquid refrigerant is vaporized from liquid to gas, while absorbing heat, within the evaporator. The gaseous refrigerant may then return to the compressor. The refrigerant subsystem may include an evaporator temperature sensor that is electrically connected to the controller 78. The sensor outputs a signal indicative of the evaporator temperature. The controller 78 may operate the system based on signals received from sensor. Alternatively, the valve may be closed to bypass the evaporator.

Another portion of the liquid refrigerant exiting the condenser (or all of the refrigerant if the valve is closed) may circulate through the second expansion device and enter the chiller 76 if the valve is open. The second expansion device, which may also be an EXV or TXV or a passive device, is adapted to change the pressure of the refrigerant. The refrigerant exchanges heat with the coolant within the chiller 76 to provide the chilled coolant to the battery 24 during a chiller mode.

The cabin heating loop 61 may include a pump 100, a heater 102, a heater core 104, and conduit 106. The conduit is configured to circulate coolant through the various components of the heating loop 61. A temperature sensor 105 may be disposed on the conduit 106 downstream of the heater 102 and upstream of the heater core 104. The temperature sensor 105 is in electric communication with the controller 78 and is configured to output data indicative of a measured temperature of the coolant. The heater 102 may be an electric heater that is powered by the battery pack 24 or other source. In one or more embodiments, the heater 102 is a PTC heater. The heater core 104 may be disposed in a HVAC unit of the vehicle 12. Typically, the HVAC unit is disposed under a dashboard in the passenger cabin. The heater core 104 is a liquid-to-air heat exchanger that transfers thermal energy from the coolant into an airstream driven by a fan 108. The airstream produced by the fan 108 is directed into the passenger compartment to provide heat.

Thermal-management system 56 may include only one heater 102 that is shared between the passenger cabin and the traction battery 24. A valve 110 selectively connects the battery loop 59 and the cabin heating loop 61 in fluid communication. The valve 110 may be an electronically controlled valve, such as a four-way valve. The valve includes at least one position (first position) in which the battery loop 59 and the cabin heating loop 61 are connected in fluid communication and at least one position (second position) in which the fluid communication between the battery loop 59 and the cabin heating loop 61 is severed, i.e., the loops 59 and 61 are isolated from each other. In FIG. 2, the first position shown in solid and the second position as shown in dashed line type.

The valve 110 may include four ports or fittings 112, 114, 116, and 118. The ports 112 and 118 connect with the conduit of the battery loop 59. The ports 114 and 116 connect with the conduit of the cabin heating loop 61. The port 112 may be the inlet port for the battery loop 59 and the port 116 may be the inlet port for the cabin heating loop 61. The port 118 may be the outlet port for the battery loop 59 and the port 114 may be the outlet port for the cabin heating loop 61. In the first position, the ports 112 and 114 are connected in fluid communication and the ports 116 and 118 are connected in fluid communication (battery and heater core in fluid communication). In the second position, the ports 112 and 118 are connected in fluid communication and the ports 114 and 116 are connected in fluid communication (battery separated from heater core).

Since the heater 102 is shared between the battery 24 and the passenger cabin, it is possible for the summation of heat requested by the passenger cabin and the traction battery to exceed the heating capabilities of the heater 102. That is, there is insufficient thermal energy to provide the requested heating simultaneously. In these instances, the thermal-management system 56 must prioritize between the passenger cabin and the battery or provide some lesser amount of heating to both systems.

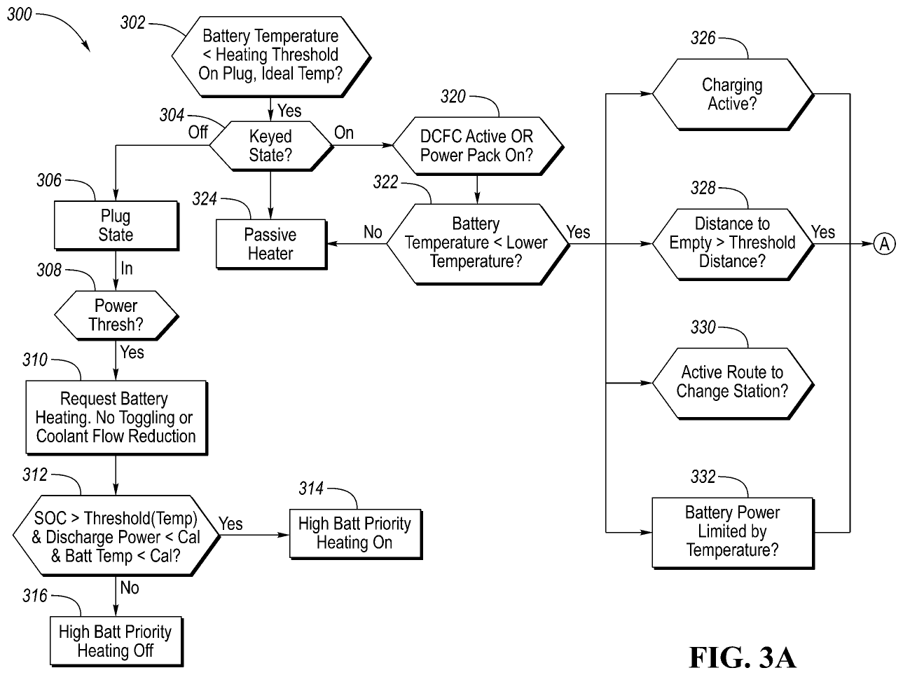

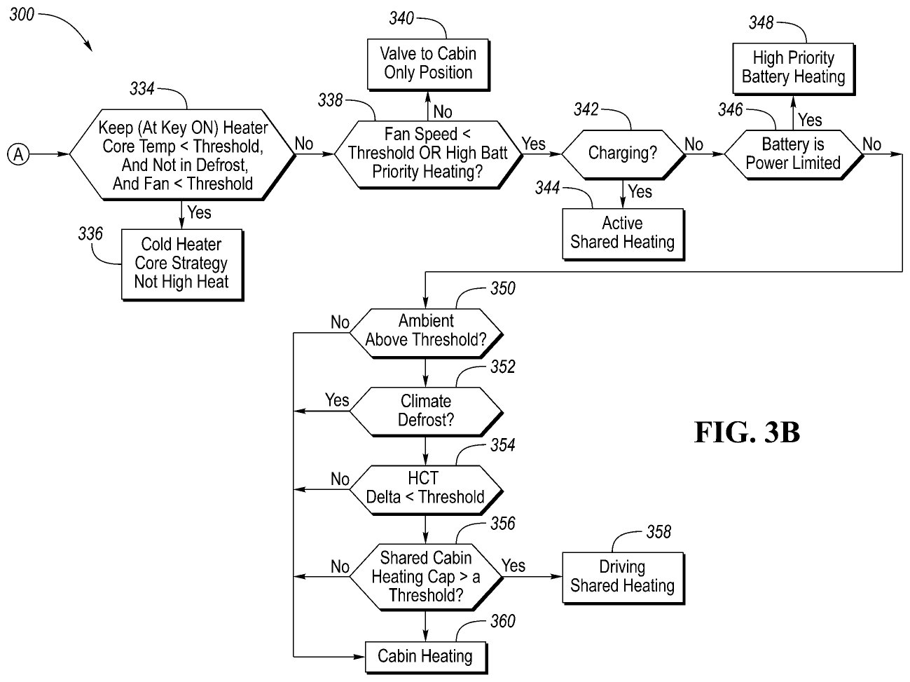

FIGS. 3A-3D illustrates a flowchart 200 of an algorithm for controlling the thermal-management system 56. Control begins at operation 302 the controller compares the battery temperature, which may be measured by a battery temperature sensor 125, to a heating threshold. The heating threshold indicates whether the battery would benefit from heating. An example temperature is 70 degrees F., but this will vary depending on the battery pack. If the battery temperatures above the threshold, controls 300 are exited.

In operation 304 the controller determines if the vehicle is KEY OFF. If the key is OFF control passes to operation 306 and the controller determines a plug state of the vehicle, i.e., is the vehicle plugged into a charging station. If the vehicle is plugged in control passes to operation 308 and the controller determines if the plug power is greater than a threshold. If yes control passes to operation 310, and the controller requests battery heating.

At operation 312, the controller determines if the state of charge of the battery is greater than a threshold (threshold is based on battery temperature), if the discharge power is less than a calibration value, and if the battery temperature is less than a calibration value. If yes, the vehicle prioritizes heating the battery and actuates the valve 110 to promote battery heating over cabin heating at operation 314. If no, the vehicle prioritizes heating the passenger cabin and actuates the valve 110 to promote cabin heating over battery at operation 316.

If the vehicle is KEY ON, the controller determines if the vehicle is actively DC fast charging or if the power pack is on. In operation 322, the controller determines if the battery temperature is less than a lower threshold. The lower threshold indicates whether there is any urgency are not in heating battery. (The lower threshold does not indicate a power-limiting temperature of the battery; that will be referred to later as the “minimum threshold.”)

While exemplary embodiments are described above, it is not intended that these embodiments describe all possible forms contemplated. The words used in the specification are words of description rather than limitation, and it is understood that various changes may be made without departing from the spirit and scope of these disclosed materials. The lower threshold is dynamic and is based on vehicle conditions. For example, the lower threshold may vary based on the plug charger power (e.g., if 20 kw, then threshold is 10° C. vs if 150 kw, then threshold is 25° C.), whether or not the vehicle is on-route to a charging station, and SOC of the battery (e.g., threshold is 5° C. if low SOC; −5° C. if medium SOC; and −20° C. if high SOC). These are, of course, nonlimiting examples.

If the battery temperature is greater than the lower threshold, passive heating is used to warm the battery at operation 324. Passive heating may refer to heating of the battery with waste heat produced by the battery, the electric machine(s), or any other component of the electric powertrain that is fluid communication with the battery. As will also be explained in more detail below, the electrical components of the electric powertrain can be operated in an inefficient mode in order to generate additional waste. This may occur within the passive heating of operation 324 depending on sensed conditions as will be explained below.

If the battery temperature is less than the lower threshold control passes to a series of operations 326-332 that identify whether or not the battery can be actively heated. In operation 326, the controller determines of the vehicle is being actively charged. In operation 328, the controller determines if the battery has sufficient SOC to drive to a charging station. The battery SOC may be converted to a distance, referred to as distance to empty. Controller may compare the distance to empty to a threshold difference. If yes, this indicates that battery SOC is sufficient to drive to a charging station. If no, this indicates that the battery SOC is insufficient to drive to his charging station. At operation 330 the controller determines if there is active route guidance to a charging station. For example, the driver select a charging station within the vehicle navigation, which then generates a route to either prompt the driver driving directions to the charging station, or in the case and an autonomous vehicle, drive the vehicle to the charging station. At operation 332, the controller determines if the battery is power limited by temperature. For example, the controller may compare a temperature of the battery to a minimum threshold temperature.

If no to any of these operations, the controller uses passive heating.

If yes to any of these operations, control passes to operation 334. In operation 334, the controller may check three conditions. The first condition is whether or not the heater core temperature was greater than a threshold at the time of KEY ON. Second condition is whether or not the HVAC is in DEFROST. The third condition is whether or not the fan speed of the HVAC is less than a threshold. If these conditions are satisfied control passes to operation 336.

At operation 336, the controller initiates the cold heater core strategy. Since the cabin was cold at KEY ON, the driver will not expect immediate heat. As such, battery heating can be prioritized for at least a duration of time. In one embodiment, the valve may be controlled so that the battery receives all of the heat for an initial duration of time at the start of the cold heater core strategy. After that time expires, the valve may be commanded to a shared position in which the battery and the heater core receive heat for a second duration of time. Expiration of the second duration may commence cabin priority heating. The customer may override this battery prioritization by increasing the blower speed or similar manipulation of the HVAC controls.

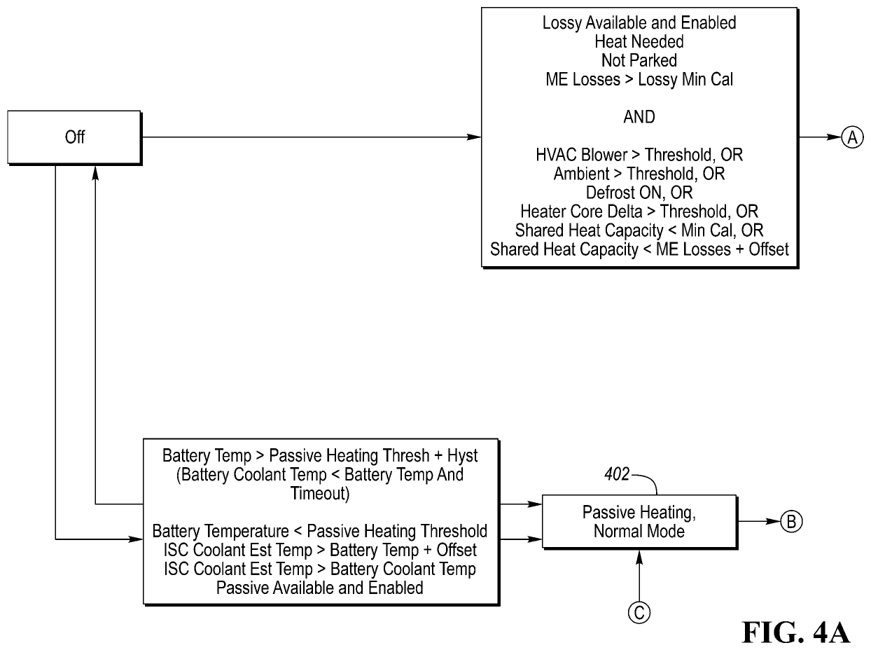

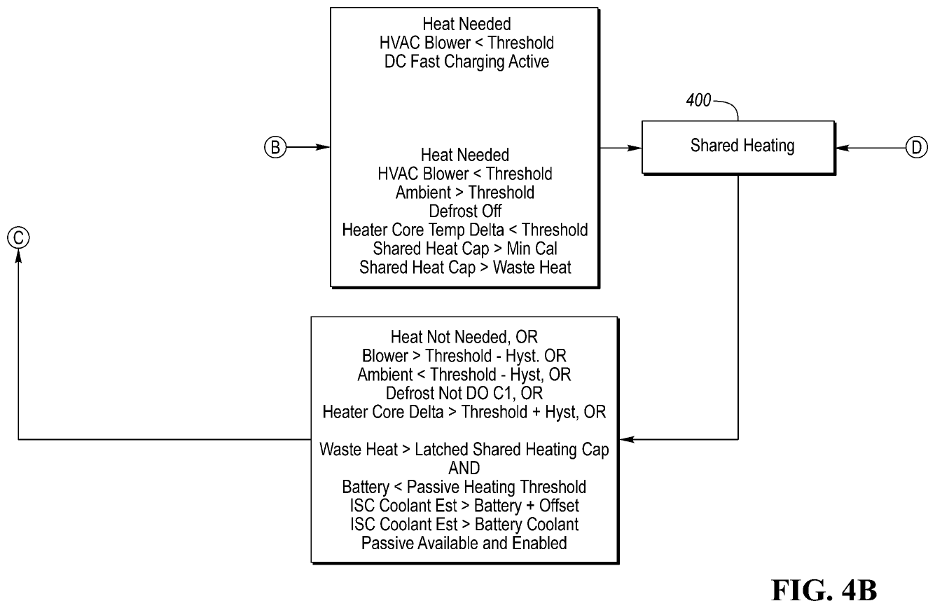

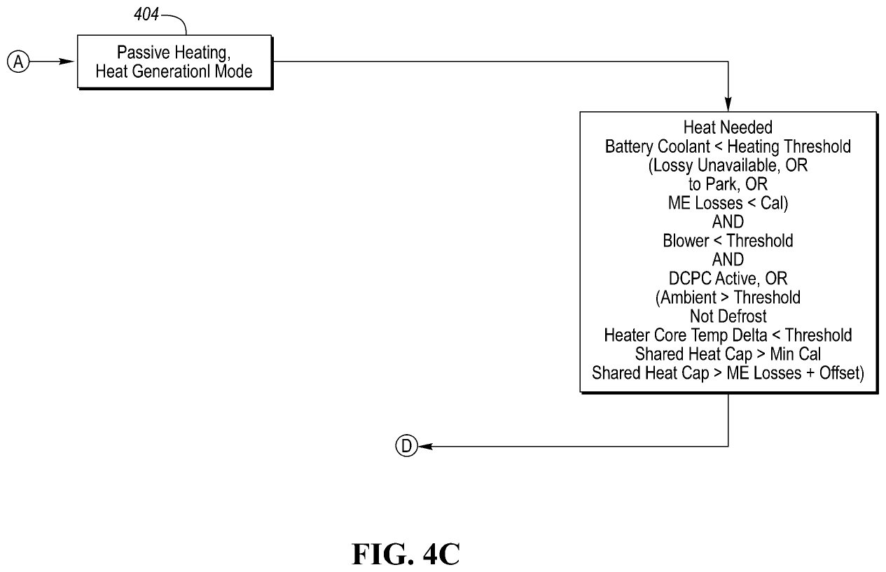

If not at operation 334, control passes to operation 338, where the controller determines if the fan speed is less than a threshold or if high battery priority heating is active. If no, control passes operation 340 and the valve is actuated to sever the cabin loop from the battery loop so that all heat generated by the heater circulated to the passenger cabin. The battery will then be passively heated using either a normal mode or a heat generating mode as we described below with reference to FIG. 4.

If yes at operation 338, control passes operation 342, where the controller determines if the vehicle is currently charging, i.e., plugged into an electric charging station. If yes, shared heating is activated by energizing the heater and actuating the valve to the shared position in which the battery loop and the cabin loop are connected include communication. Depending upon sensed conditions, toggling of the valve may or may not occur during the shared heating. Toggling refers to relatively rapid switching in succession of the valve between a position in which the cabin loop and battery loop are in fluid communication and another position in which the cabin loop in the battery loop are not in fluid communication (severed). The frequency of the titling is based on sensed conditions such as the ambient temperature, the temperature of the battery, the set point of the HVAC, and the temperature of the passenger cabin. In some embodiments, and based on sensed conditions, the valve may toggle between the valve positions at least 2 times per minute. In other embodiments, and based on sensed conditions, the valve may toggle between the valve positions anywhere between 3 to 50 times per minute. In yet embodiments, and based on sensed conditions, the valve may toggle between the valve positions anywhere between 2 to 50 times per 10 minutes. In one or more embodiments, the controller may toggle the valve during operation 144 when the ambient temperature is less than a threshold, and may not toggle when the ambient temperature is greater than the threshold. The toggling results in the passenger cabin receiving more heat than compared to a constant shared position of the valve.

If no at operation 342, control passes to operation 346, where the controller determines whether battery is power limited. The vehicle may determine whether or not the battery is power limited by monitoring the discharge power of the battery. If the discharge power is low, this means that the battery may have insufficient power to provide the driver-demanded torque.

If yes, control passes to operation 348 and the controller activates high-priority battery heating mode. In this mode, the battery is prioritized over the cabin. However, this does not necessarily mean that the cabin receives no heat. Depending upon sensed conditions, the cabin may receive some heat as long as there is also sufficient heat for the battery. In one or more embodiments, the high-priority battery heating mode may employ toggling in order to provide the appropriate balance between battery heating cabin. In other embodiments, or under other sensed conditions, toggling may not occur. In some embodiments, or alternatively, under some sensed conditions, the fan speed associated with the HVAC fan may be reduced to low to provide some cabin heating while majority of the heating is routed to the traction battery.

In operation 350, the controller determines of the ambient temperatures above the threshold. If yes, control passes to operation 352 and the controller determines if cabin defrost is requested by the driver. If no, control passes to operation 354 and the controller determines if a heater core delta is less than a threshold. If yes, control passes operation 356 and the controller determines if a shared cabin heating capacity is greater than a threshold, that is, if there would be any heat left for the battery after satisfying cabin demand. If yes, control passes operation 358 and a shared heating mode is activated. At operation 358, the valve is actuated so that heat from the heater can be routed to the battery and the cabin. In some embodiments, the valve may be toggled as described above.

If the conditions for shared heating are not satisfied, control passes to operation 360 where the valve is actuated for cabin heat only. At operation 360 all the heat energized by the heater is circulated to the heater core and the battery is heated using waste heat generated by one or more components of the electric powertrain.

As described above, in certain situations the battery is heated using waste heat produced by one or more components of the electric powertrain. This may be referred to as passive heating. During passive heating, it is possible to operate one or more components of the electric powertrain inefficiently in order to produce more waste heat than would otherwise occur. That is, the vehicle may command power from the electric powertrain in a normal efficient mode and an inefficient heat-generating mode that produces more heat than the normal mode. For example, the power electronics, the battery, the motor, etc., can be operated such that, for a given power input or output, more heat is generated than in the normal mode. In one example, for a given power output, the battery generates more heat in the heat-generating mode than in the normal mode. In another example, the power electronics, for a given power input, converts more of that input into heat when in the heat-generating mode than in the normal mode. These, of course, are merely examples and the excess heat may be generated in the heat-generating mode in other ways.

FIG. 4 diagrammatically illustrates logic for switching between the shared heating mode 400, a passive heating mode in which the electric powertrain components are operated normally 402, a passive heating mode in which one or more components of the electric powertrain is operated in a heat generating mode 404.

The controller may consider many factors is determining whether to passively heat using normal mode of heat-generating mode. For example, the controller may command power to the electric machine according to a heat-generating mode that operates inefficiently to produce extra heat from the battery and the electric machine responsive to (i) a temperature of the battery being less than a threshold temperature, (ii) active route guidance to a charging station and (ii) an estimated distance to empty being greater than a threshold distance. The controller may command power to the electric machine according to a normal mode, responsive to (i) the temperature of the battery being less than the threshold temperature, (ii) active route guidance to a charging station, and (iii) the estimated distance to empty being greater than the threshold distance.

The controller may be further programmed to command power to the electric machine according to the heat-generating mode responsive to (i) the temperature of the battery being less than the threshold temperature and a state of charge of the battery being greater than a threshold. The controller may be further programmed to command power to the electric machine according to the normal mode, responsive to (i) the temperature of the battery being less than the threshold temperature and the state of charge of the battery being less than a threshold.

As further shown in FIG. 4, further condition changes may result in a change from passive heating to active heating of the battery in the shared mode 400. For example, shared heating may be commanded based on fan speed of the HVAC, the charging status, the ambient temperature, whether the cabin defrost is on or off, whether or not the heater core temperature delta is less than a threshold, and an estimated shared heating capacity. In one example, shared heating will be commanded if the fan speed is less than the threshold and the battery is being charged. In another example, shared heating will be commanded if the fan speed is less than the threshold, the ambient temperature is greater than the threshold, the defrost is off, the heater core temperature delta is less than the threshold, the shared heating capacity is greater than a minimum calibration, and the shared heating capacity is greater than the waste heat generated by the electric powertrain.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a traction battery;
an electric machine powered by the traction battery and configured to power wheels of the vehicle;
a thermal-management system including:
a battery loop configured to circulate coolant through the traction battery,
a cabin heating loop configured to circulate coolant through a heater and a heater core,
a blower configured to circulate air through the heater core to heat a passenger cabin of the vehicle, and
a valve configured to fluidly connect the battery loop and the heating loop when the valve is in a first position and configured to fluidly isolate the battery loop from the heating loop when the valve is in a second position; and
a controller programmed to, responsive to (i) the battery charging, (ii) a temperature of the battery being less than a first threshold, and (iii) a temperature of the heater core being greater than a second threshold, energize the heater and command the valve to toggle between the first and second positions in succession such that heat generated by the heater is circulated to the battery and the heater core.

2. The vehicle of claim 1, wherein the valve toggles between the first and second positions such that the valve switches between the first and second positions at least two times per minute.

3. The vehicle of claim 1, wherein the controller is further programmed to reduce a speed of the blower responsive to (i) the battery charging, (ii) the temperature of the battery being less than the first threshold, and (iii) the temperature of the heater core being less than the second threshold.

4. The vehicle of claim 1, wherein the first threshold is a dynamic value.

5. The vehicle of claim 4, wherein the first threshold is based on a state of charge of the battery.

6. The vehicle of claim 1, wherein the controller is further programmed to, in response to the temperature of the battery exceeding a third threshold, end the toggle and actuate the valve to the first position.

7. The vehicle of claim 1 further comprising:
a power-electronics module; and
a second valve that selective connects the battery and power-electronics module in fluid communication.

8. A vehicle comprising:
an electric powertrain including a traction battery and an electric machine powered by the traction battery; and
a controller programmed to, responsive to a temperature of the battery being less than a threshold temperature and an estimated distance to empty being greater than a threshold distance, command power to the electric machine according to an inefficient heat-generating mode that produces more heat from the battery and the electric machine than an efficient normal mode of operating the battery and the electric machine.

9. The vehicle of claim 8, wherein the controller is further programmed to, responsive to the temperature of the battery being less than the threshold temperature and the estimated distance to empty being less than the threshold distance, command power to the electric machine according to the normal mode.

10. The vehicle of claim 9, wherein the controller is further programmed to, responsive to (i) the temperature of the battery being less than the threshold temperature and a state of charge of the battery being greater than a threshold, command power to the electric machine according to the heat-generating mode.

11. The vehicle of claim 8, wherein the temperature threshold is a dynamic value.

12. The vehicle of claim 11, wherein the temperature threshold is based on a state of charge of the battery.

13. The vehicle of claim 8, wherein the controller is further programmed to, responsive to (i) the temperature of the battery being less than the threshold temperature and a state of charge of the battery being greater than a threshold, command power to the electric machine according to the heat-generating mode.

14. The vehicle of claim 13, wherein the controller is further programmed to, responsive to (i) the temperature of the battery being less than the threshold temperature and the state of charge of the battery being less than a threshold, command power to the electric machine according to the normal mode.

15. The vehicle of claim 8 further comprising:
a battery heating loop configured to circulate coolant through the battery;
a cabin heating loop configured to circulate coolant through a heater core; and
a valve configured to fluidly connect the battery loop and the heating loop when the valve is in a first position and configured to fluidly isolate the battery loop and the heating loop when the valve is in a second position.

16. The vehicle of claim 15, wherein the controller is further programmed to, responsive to the temperature of the battery being less than the threshold temperature and cabin heating being requested:
command the valve to the first position when an estimated heating capacity exceeds a third threshold, and
command the valve to the second position when the estimated heating capacity is less than the third threshold.

17. The vehicle of claim 15, wherein the controller is further programmed to, in response to cabin heating being requested and the battery being power-limited due to low temperature, command the valve to toggle between the first and second positions in succession such that heat generated by the heater is circulated to the battery and the heater core.

18. The vehicle of claim 17, wherein the valve toggles between the first and second positions such that the valve switches between the first and second positions at least two times per minute.

19. A method of heating a vehicle battery comprising:
responsive to a temperature of a battery being less than a threshold temperature and an estimated distance to empty being greater than a threshold distance, switching from an efficient normal operating mode to an inefficient heat-generating mode such that the battery, for a given power output, produces more heat compared to the normal operating mode.

20. The method of claim 19 further comprising:
responsive to the temperature of the battery being less than the threshold temperature and the estimated distance to empty being less than the threshold distance, switching from the heat-generating mode to the normal mode such that the battery, for a give power output, produces less heat compared to the heat-generating mode.
